(19) United States
(12) Patent Application Publication
(10) Pub. No.: US 2007/0284211 A1
(43) Pub. Date: Dec. 13, 2007

(54) Electric Hub Having Clutch Means

(76) Inventors: Cheng-Shing Tin, Sindian City (TW); Shen-Yang Mao, Sindian City (TW); Cheng-Wei Tsai, Sindian City (TW)

Correspondence Address: HDSL, 4331 STEVENS BATTLE LANE, FAIRFAX, VA, 22033, US

(21) Appl. No.: 11/423,733

(22) Filed: Jun. 13, 2006

(51) Int. Cl. F16D 11/04

(52) U.S. Cl. 192/69.4

(57) ABSTRACT

An electric hub having a clutch means is used in wheels of an electric wheelchair and includes a hub means, a clutch means and an elastic body. The hub means includes an outer hub and an inner hub provided in its interior. The end face on one side of the outer hub is provided with a first gear. A projecting shaft extends from one side of the inner hub to correspond to the first gear. One side of the hub means is connected to the clutch means. The clutch means includes a rotary assembly and a movable disk connected to the projecting shaft. The movable disk is movable relative to the axial direction of the projecting shaft. A mating second gear is provided to correspond to the first gear. The elastic body is provided between the inner hub and the movable disk to control the clutching operation between the outer hub and the movable disk. With this arrangement, the manual or electric operation mode can be switched according to the practical condition, thereby to increase the practicability and convenience of the electric hub.

### BACKGROUND OF THE INVENTION

1. Field of the Invention

The present invention relates to an electric hub having a clutch means, and in particular an electric hub capable of being applied to the wheels of walking aids such as electric wheelchair.

2. Description of Prior Art

The conventional wheelchairs for handicapped people are categorized into manual wheelchairs and electric wheelchairs. The manual wheelchair can be operated to move by the caretaker pushing the wheelchair or by the handicapped person who sits thereon rotating the wheels with his/her hands. However, when the manual wheelchair is to move a long distance or drive up hills, such an operation certainly causes the caretaker or the handicapped person more physical and spiritual fatigue. Therefore, there is proposed an electric wheelchair, in which an electric hub is mounted on the wheel of the wheelchair. With the electric hub, the rotation of the wheels can be controlled by means of the electronic circuit, so that the wheelchair is electric-powered to move without the physical force of the user.

However, in the case of controlling the movement of the wheelchair by the electric hub, due to the running of the motor and the mutual transmission among each constituent component, unfavorable noise will be inevitably generated and thus it is not suitable to use the electric hub in some places especially need quiet. Further, owing to the exhaustion of the battery or the damage of internal components, the control of the electric wheelchair may get worse after the long-term use of the electric hub. Therefore, it is an important issue to propose an electric hub having a clutch means, by which the manual or electric operation mode can be switched according to the practical use or emergent situation to improve the practicability and convenience of the electric hub.

In view of the above, the inventor proposes the present invention to overcome the above problems based on his expert experiences and deliberate researches.

### SUMMARY OF THE INVENTION

The present invention is to provide an electric hub having a clutch means, in which a clutching operation can be performed between an outer hub and a movable disk, so that the electric hub can switch to the manual or electric operation mode according to the practical condition to improve the convenience thereof.

the present invention provides an electric hub having a clutch means, which is used in the wheels of the walking aids such as wheelchairs and comprises a hub means, a clutch means and an elastic body. The hub means comprises an outer hub and an inner hub provided in its interior. The end face on one side of the outer hub is provided with a first gear. A projecting shaft extends from the inner hub to correspond to one side of the first gear. One side of the hub means is connected to the clutch means. The clutch means comprises a rotary assembly and a movable disk connected to the projecting shaft of the inner hub. The movable disk is movable relative to the axial direction of the projecting shaft. A mating second gear is provided to correspond to the first gear of the outer hub. The elastic body is provided between the corresponding end faces of the inner hub of the hub means and the movable disk of the clutch means. The elastic body is used to control the clutching operation between the outer hub and the movable disk.

### BRIEF DESCRIPTION OF THE DRAWINGS

FIG. 1 is an exploded perspective view of the present invention;

FIG. 2 is a partially assembled schematic view of the present invention;

FIG. 3 is a partially assembled cross-sectional view of the present invention;

FIG. 4 is an assembled schematic view showing that the present invention is applied to an electric wheelchair; and

FIG. 5 is a partially cross-sectional view showing the movable disk and the outer hub of the present invention are disengaged from each other.

### DETAILED DESCRIPTION OF THE INVENTION

The detailed description and the technical contents of the present invention will be made with reference to the accompanying drawings. However, it should be understood that the drawings are illustrative but not used to limit the scope of the present invention.

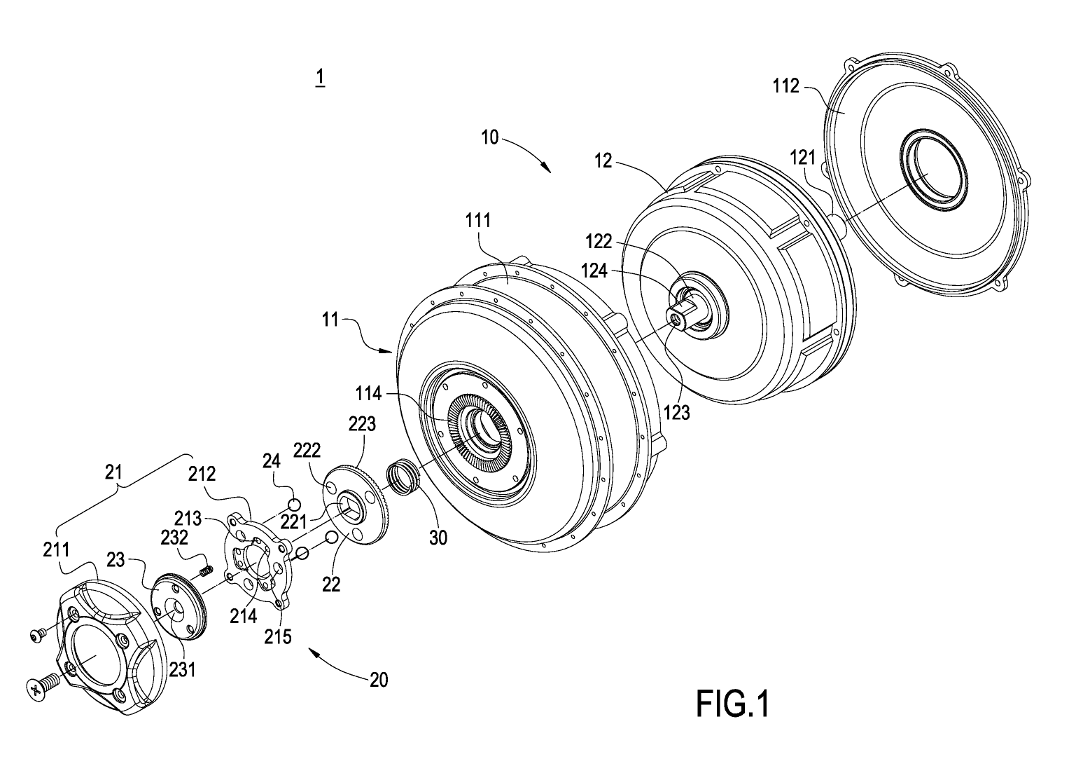

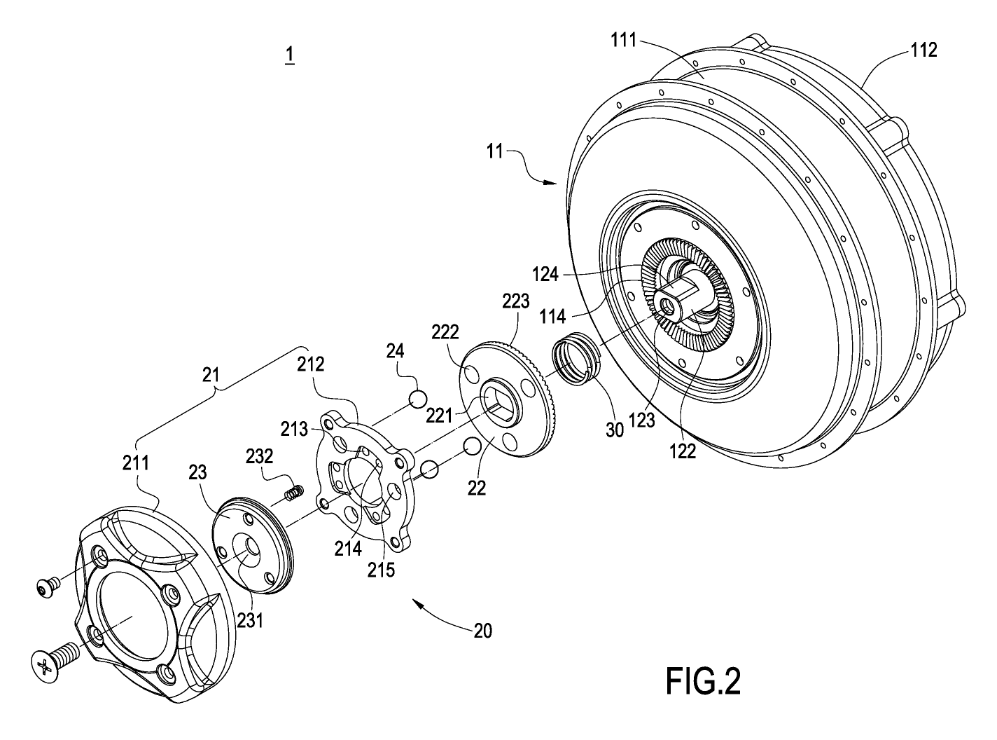

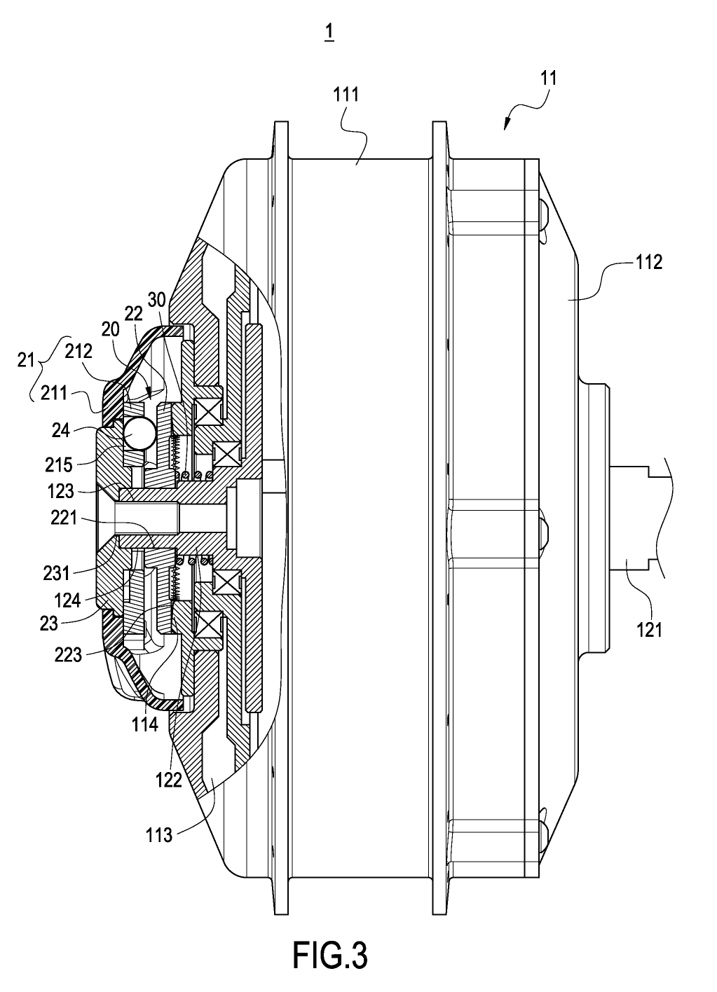

FIG. 1 is an exploded perspective view of the present invention. FIG. 2 is a partially assembled schematic view of the present invention. FIG. 3 is a partially assembled cross-sectional view of the present invention. The present invention provides an electric hub having a clutch means, which mainly comprises a hub means 10, a clutch means 20 and an elastic body 30.

The hub means 10 comprises an outer hub 11 and an inner hub 12. The outer hub 11 comprises a circular left shell 111 and a circular right shell 112 assembled on one side thereof. An accommodating chamber 113 (as shown in FIG. 3) is formed between the left shell 111 and the right shell 112. Outside the left shell 111, a first gear 114 is provided. The first gear 114 is a face gear. The inner hub 12 is accommodated in the accommodating chamber 113 of the outer hub 11. The outer hub 11 can be switched to rotate relative to the inner hub 12. In the center of the inner hub 12, a fixing shaft 121 projects from the outside of the right shell 112. A projecting shaft 122 extends from one side of the inner hub 12 to correspond to the first gear 114 of the left shell 111. The shaft center outside the projecting shaft 122 is provided with an inner thread 123, and the outside of the projecting shaft is provided with two positioning faces 124 parallel to each other. The interior of the inner hub 12 is provided with transmission means such as rotors, stators or coils and other components (not shown).

The clutch means 20 is connected to one side of the hub means 10 and comprises a rotary assembly 21, a movable disk 22 connected to the projecting shaft 122 of the inner hub 12 and a fixing plate 23 clamped in the rotary assembly 21 and fixedly connected to the projecting shaft 122. The rotary assembly 21 comprises an outer cover 211 and a rotary disk 212 fixedly connected to the inside of the outer cover 211. Through holes 213, 214 are provided on the outside of the rotary disk 212. In the present embodiment, three sets of through holes are provided. In the space between each set of through holes 213, 214 is provided with a receiving hole 215. Each receiving hole 215 is used for accommodating a steel ball 24.

The center of the movable disk 22 is formed with a capsular shaft hole 221 for connecting on the positioning face 124 of the projecting shaft 122, so that the movable disk 22 can only moved in the axial direction of the projecting shaft 122. Outside of the shaft hole 221 of the movable disk 22, tapered holes 222 are provided to correspond to the receiving holes 215. A portion of the steel ball 24 can be accommodated in the tapered hole 222. On the end face of the movable disk 22 corresponding to the left shell 111 of the outer hub 11, a second gear 233 is provided to mate with the first gear 114. The second gear is also a face gear.

The center of the fixing plate 23 is provided with a through hole 231 to correspond to the inner thread 123 of the projecting shaft 122. A fixing element such as screw can be inserted through the through hole and fixed on the end face of the projecting shaft 122. Inside the fixing plate 23, a plurality of elastic positioning pins 232 are provided. The positioning pin 232 is provided to correspond to each through hole 213, 214 so as to be inserted into proper position.

The elastic body 30 can be a spiral spring. Both end faces of the elastic body abut against the corresponding end faces of the inner hub 12 of the hub means 10 and the movable disk 22 of the clutch means 20, respectively, thereby to control the clutching operation between the outer hub 12 and the movable disk 22.

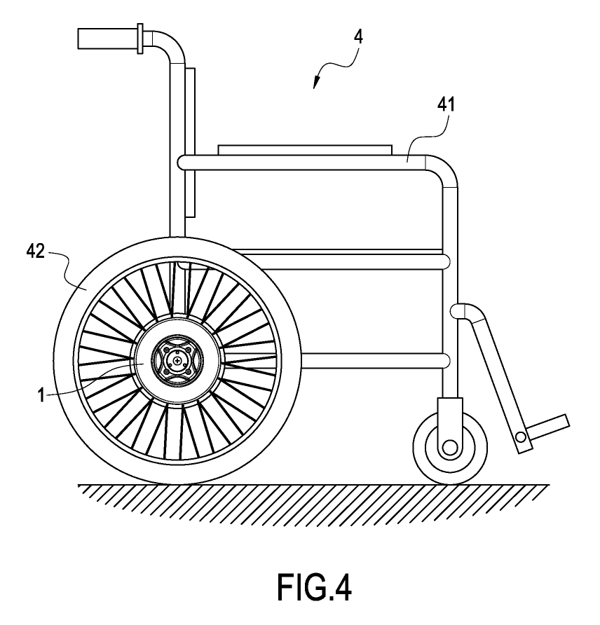

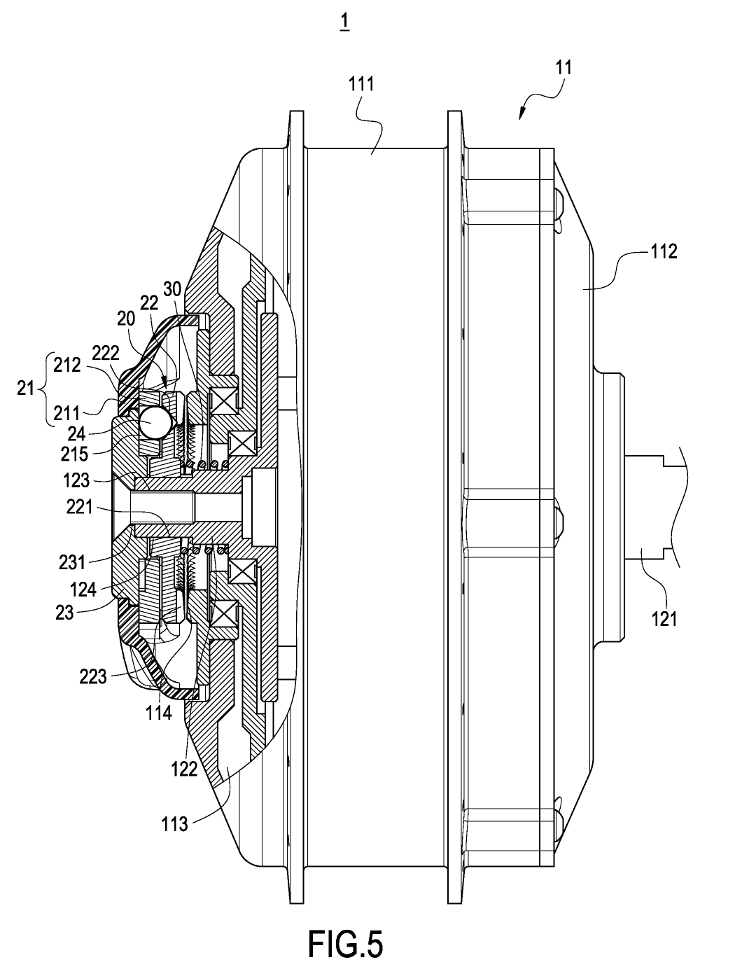

FIG. 4 is an assembled schematic view showing that the present invention is applied to an electric wheelchair, and FIG. 5 is a partially cross-sectional view showing the movable disk and the outer hub of the present invention are disengaged from each other. The electric hub 1 of the present invention can be mounted on an electric wheelchair 4. The electric wheelchair 4 has a seat 41 and wheels 42 connected to both sides of the seat 41. The electric hub 1 is mounted in the center of the wheel 42 of the electric wheelchair 4. When the electric hub 1 is electric-powered, since the positioning face 124 of the projecting shaft 122 engages with the shaft hole 221 of the movable disk 22 and the fixing plate 23 is locked on the end face of the projecting shaft 122 by screws, the rotation of the inner hub 12 can drive the rotary assembly 21 and the movable disk 22 to rotate together. Further, since the second gear 223 of the movable disk 22 engages with the first gear 114 of the outer hub 11, the outer hub 11 can rotate synchronously with the inner hub 12.

When the user intends to switch the electric hub 1 to a manual operation mode, he/she rotates the outer cover 211 to remove the positioning pins 232 of the fixing plate 23 from the through holes 214 and then penetrate into the through holes 213, the steel balls 24 accommodated in the receiving holes 215 can be exactly rotated and pushed into the tapered holes 222 of the movable disk 22. Then, the elastic force of the elastic body 30 pushes the movable disk 22 to move outwardly, so that the second gear 223 of the movable disk 22 disengages from the first gear 114 of the left shell 111. As a result, the outer hub 11 disengages from the inner hub 12 and thus can rotate freely.

According to the above, the user can rotate the rotary assembly 21 to switch to the manual or electric operation mode according to the practical condition, thereby to greatly improve the practicability and convenience of the electric hub 1. Further, since the first gear 114 mates with the second gear 223, the engagement between these two gears is firm and the alignment is very accurate. Further, the steel balls 24 can be switched to rotate into the tapered holes 222 of the movable disk 22, and thus it is much smoother and easier to perform the switching operation.

According to the above, the present invention entitled “Electric Hub Having Clutch Means” indeed achieves the desired effects and overcomes the drawbacks of prior art by employing the above structures. Further, the present invention has not been published or put to public use prior to applying for patent, and involves the novelty and inventive steps. Therefore, the present invention conforms to the requirements for a utility model patent.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. An electric hub having a clutch means, comprising:
a hub means comprising an outer hub and an inner hub provided in an interior thereof, one end face of the outer hub provided with a first gear, and a projecting shaft extending from one side of the inner hub to correspond to the first gear;
a clutch means connected to one side of the hub means, the clutch means comprising a rotary assembly and a movable disk connected to the projecting shaft of the inner hub, the movable disk movable relative to an axial direction of the projecting shaft, and a mating second gear provided to correspond to the first gear of the outer hub; and
an elastic body with both ends abutting against corresponding end faces of the inner hub of the hub means and the movable disk of the clutch means, respectively, to control the clutching operation between the outer hub and the movable disk.

2. The electric hub having a clutch means according to claim 1, wherein the outer hub comprises a left shell and a right shell assembled to one side thereof, and an accommodating chamber is formed between the left shell and the right shell for accommodating the inner hub.

3. The electric hub having a clutch means according to claim 2, wherein the outer hub is capable of being switched to rotate relative to the inner hub.

4. The electric hub having a clutch means according to claim 1, wherein the first gear and the second gear are face gears.

5. The electric hub having a clutch means according to claim 1, wherein an outside of the projecting shaft of the inner hub is provided with positioning faces, a center of the movable disk is formed with a shaft hole, and the shaft hole mates with the positioning faces to cause the movable disk to only move in the axial direction of the projecting shaft.

6. The electric hub having a clutch means according to claim 1, wherein the clutch means further comprises a fixing plate, and the fixing plate is clamped within the rotary assembly and fixedly connected on the projecting shaft.

7. The electric hub having a clutch means according to claim 6, wherein the projecting shaft of the inner hub is provided with an inner thread, a center of the fixing plate is provided with a through hole, a fixing element penetrates into the through hole to fix the fixing plate on the end face of the projecting shaft.

8. The electric hub having a clutch means according to claim 6, wherein the rotary assembly comprises an outer cover and a rotary disk fixedly connected to an inside of the outer cover, at least two through holes are provided on the rotary disk, positioning pins are provided inside the fixing plate to correspond to each through hole, and the positioning pins are inserted into the through holes in position.

9. The electric hub having a clutch means according to claim 8, wherein receiving holes are provided on the rotary disk, tapered holes are provided on the movable disk to correspond to the receiving holes, and a portion of the steel ball is accommodated in the tapered hole and fixed thereto.

10. The electric hub having a clutch means according to claim 1, wherein the elastic body is a spiral spring.
